(19) United States
(12) Patent Application Publication
(10) Pub. No.: US 2015/0246305 A1
(43) Pub. Date: Sep. 3, 2015

(54) Plastic membrane housing for ceramic membranes

(71) Applicant: Johannes A. Thomassen, Frauenfeld (CH)

(72) Inventor: Johannes A. Thomassen, Frauenfeld (CH)

(21) Appl. No.: 14/632,368

(22) Filed: Feb. 26, 2015

Related U.S. Application Data
(60) Provisional application No. 61/946,852, filed on Mar. 2, 2014.

(51) Int. Cl. B01D 35/30; B32B 37/18; B32B 37/12

(52) U.S. Cl. CPC B01D 35/30; B32B 37/1292; B32B 37/18; B32B 2439/00

(57) ABSTRACT

A membrane housing-module includes flange adaptors, a permeate discharge tube, membrane pipe plates, and a flange adapter tee connection tube, such that the housing module forms a seal between a concentrate phase and a permeate phase, and a plurality of glue surfaces are arranged so as to provide sufficient structural integrity to the membrane housing-module, such that when one or more membranes are inserted therein, the membrane housing assembly is rigid, so as to prevent the membranes from being subjected to lateral forces or movement during use. A by-pass control-tube, with an increasing open area, can be configured inside the permeate discharge tube, to reduce a pressure drop over the by-pass control tube, along a path of permeate-filtrate flow. Methods of manufacturing and using a membrane housing-module are also disclosed.

### CROSS-REFERENCE TO RELATED APPLICATIONS

This United States Non-Provisional application claims the benefit of U.S. Provisional Application No. 61/946,852, filed Mar. 2, 2014.

### FIELD OF THE INVENTION

The present invention relates generally to the field of membrane housing-modules and, more particularly, to a membrane housing-module for ceramic membranes.

### BACKGROUND OF THE INVENTION

In membrane separation technology, several types of membranes, membrane materials and configurations of membranes are used. The membrane configurations commonly used in the market are either spiral wound, plate-and-frame, hollow-fiber, or tubular. Membrane materials are either organic or inorganic. Ceramic monolithic membranes are made of inorganic materials like aluminum-oxide or silicon-carbide. Because the channels in the ceramic monolith can be classified as tubes, they are generally classified as tubular membranes.

All membrane configurations require housings, i.e., modules, to hold the membranes, because there are three phases in any membrane separation process: the atmospheric phase, the concentrate phase, and the permeate or filtration phase. Liquid for treatment is pumped from an atmospheric condition into the membrane system/module and enters the pressurized concentrate part. The pressure applied to the concentrate phase allows liquid to pass through the semi-permeable membrane to the permeate-filtrate side of the membrane. In order to isolate the atmospheric phase from the concentrate and permeate phase, a membrane housing which can accommodate this is required.

To withstand the pressure loads generated during membrane separations, membrane housings in which membrane elements are installed must meet stringent requirements for structural rigidity. Membrane housings must be able to withstand greater forces because the operating pressures generated during membrane separation processes can exert lateral forces onto the membranes, causing breakage and failure.

Different membrane configurations each have specific housing configurations, and various materials are used to accommodate the process conditions of the various membranes. In the ceramic monolithic configuration, mostly stainless steel materials are used. The main reason for using stainless steel materials is the requirement of stiffness in the membrane housing-module to prevent the ceramic monoliths from being subjected to lateral forces because even the slightest lateral force will crack or destroy the ceramic monolith. In a number of applications, stainless steel cannot be used and normally higher-grade metallic alloys must be used. The use of these alloys, however, greatly increases the cost of the housing-module and limits the use and flexibility of more common materials.

As such, before the present invention, there was a need for a housing-module design that provided ample lateral rigidity so as to prevent breakage of the ceramic monoliths, while at the same time, being capable of construction using less expensive materials using less costly manufacturing means.

Therefore, considering the foregoing, it may be appreciated that there continues to be a need for novel and improved devices and methods for membrane housing-module designs.

### SUMMARY OF THE INVENTION

The foregoing needs are met, to a great extent, by the present invention, wherein in aspects of this invention, enhancements are provided to the existing model of membrane housing-module designs, particularly related to use with ceramic membrane monoliths.

In various aspects, an object of the invention is to provide a membrane housing-module for membrane monoliths that is manufactured using low cost materials and cost-effective manufacturing methods, while providing high lateral rigidity to prevent breakage of the membranes. Membrane elements should be easy to install in a membrane housing-module, while the membrane housing-module simultaneously should provide a pressure resistant sealing of the head ends of the membrane housing-module, and ensure structural rigidity against forces generated during use. In certain embodiments, the membrane housing-module may be constructed from non-metal alloy materials, e.g., plastic materials. While plastic membrane housing-modules for organic membranes have previously been made, such housing-modules have different design features and characteristics.

According to aspects of the present invention, a membrane housing-module is provided having an elongated body forming a seal between the concentrate phase and permeate phase, and a plurality of glue surfaces arranged so as to provide sufficient structural integrity to the membrane housing-module, such that when one or more membranes are inserted therein, the membrane housing assembly is rigid, so as to prevent the membranes from being subjected to lateral forces or movement during use.

According to aspects of the present invention, the membrane housing-module may be configured to house at least one membrane monolith. The number of membranes can be varied by varying the size and diameter of the elements selected for manufacturing a membrane housing-module according to aspects of the present invention.

In certain aspects, the present invention includes a membrane housing-module having a plurality of membrane housing-module elements assembled, so as to be adhered at a plurality of glue surfaces. The membrane housing-module elements and the locations of the glue surfaces should be selected so as to provide lateral rigidity to membrane(s) installed into the membrane housing-module. In some aspect, the present invention may be configured to include permeate discharge tubes glued in membrane pipe plates that are glued to a tee-section and a flange adaptor tee connection tube. In certain aspects, the flange adaptor tee connection tube may also be glued to the tee-section. In some embodiments, the tee-section is constructed from plastic materials.

Membrane housing-modules according to aspects of the present invention have a number of advantages over metal alloy designs such as lower cost of materials and manufacturing costs, higher chemical resistance, easier assembly of the membrane housing-module to a membrane system. High strength housings at low cost are achieved as a result of the use of the design in accordance with aspects of the present invention, including glued parts for structural rigidity.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows a perspective view of a membrane housing-module, according to an embodiment of the invention.

FIG. 2 shows a cross-sectional side view of a membrane housing-module of FIG. 1, according to an embodiment of the invention.

FIG. 3 shows a cross-sectional side view of the top half of the membrane housing-module of FIG. 1, according to an embodiment of the invention.

FIG. 4 shows a cross-sectional view of the membrane housing-module of FIG. 1, illustrating the locations where the membrane housing elements are adhered to each other, according to an embodiment of the invention.

FIG. 5 shows the membrane housing-module of FIG. 1 with the backing flanges and flange bolts removed, according to an embodiment of the invention.

FIG. 6 shows the membrane housing-module of FIG. 5 with the bolts removed, according to an embodiment of the invention.

FIG. 7 shows the membrane housing-module of FIG. 6 with the pressure plates removed, according to an embodiment of the invention.

FIG. 8 shows a cross-section view of the membrane housing-module of FIG. 7 with flange adaptors removed, according to an embodiment of the invention.

FIG. 9 shows the cross-section view of the membrane housing-module of FIG. 8 with membrane plates removed, according to an embodiment of the invention.

FIG. 10 shows a pipe bundle inside the membrane housing-module of FIG. 1, according to an embodiment of the invention.

FIG. 11 shows the pipe bundle of FIG. 10 with the tubes removed, according to an embodiment of the invention.

FIG. 12 shows a cross-sectional view of a membrane housing-module, wherein the permeate discharge tubes are configured in interconnected segments, according to an embodiment of the invention.

FIG. 13 shows a cross-sectional view of a membrane inside a by-pass control tube with a lip-seal type variable pitch, according to an embodiment of the invention.

FIG. 14 shows a cross-sectional view of a membrane inside a by-pass control tube configured with a lip-seal type variable pitch, according to an embodiment of the invention.

FIG. 15 shows a cross-sectional view of a membrane inside a by-pass control tube configured with a spacer type variable pitch, according to an embodiment of the invention.

FIG. 16 shows an exploded perspective view of the membrane housing-module of FIG. 1, according to an embodiment of the invention.

FIG. 17 shows a cross-section perspective view of a membrane housing-module, wherein the permeate discharge tubes are configured in interconnected segments, according to an embodiment of the invention.

FIG. 18 shows a schematic diagram for a configuration of recirculation flow established for a membrane housing-module, according to an embodiment of the invention.

FIG. 19 shows a graph of trans-membrane pressure across a length of a membrane, for variable and fixed open areas of the by-pass control tube, according to embodiments of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

Throughout this disclosure spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the housing in use or operation in addition to the orientation depicted in the figures. For example, if the housing in the figures is turned over, elements described as “below” or “beneath” other elements or features would then be oriented “above” the other elements or features. The device may be otherwise oriented (rotated 90 degrees or at other orientations) and the spatially relative descriptors used herein interpreted accordingly.

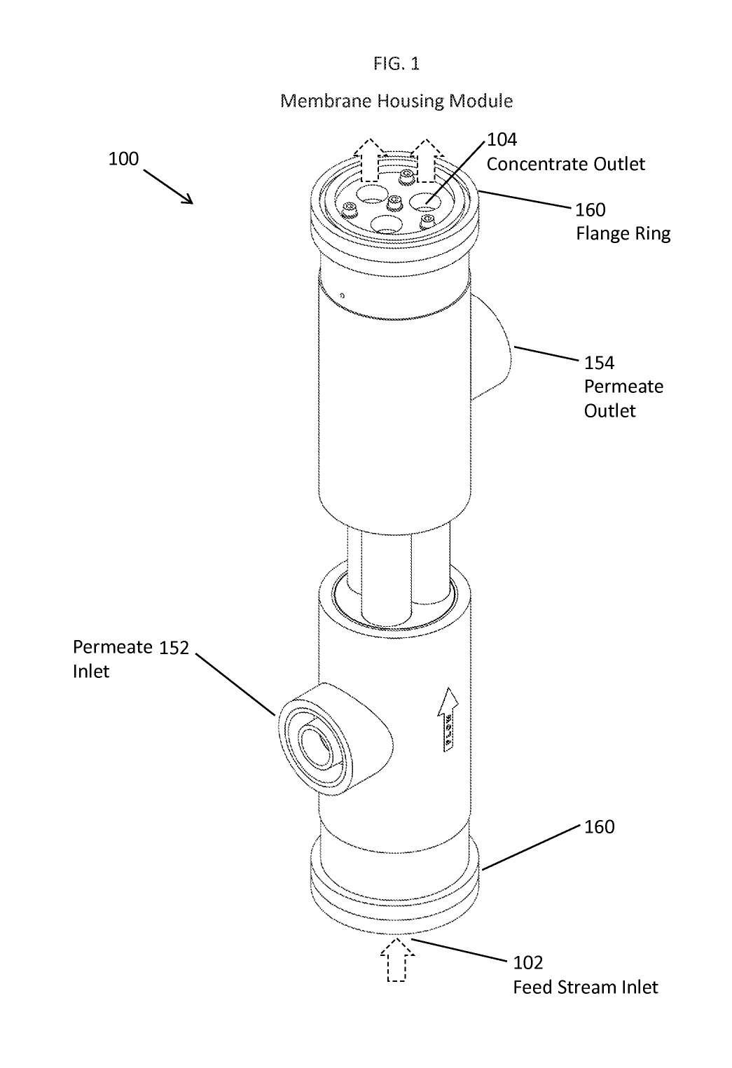

Referring to the embodiment of FIG. 1, a membrane housing-module 100 is illustrated having permeate outlets and inlets 154 152, with flange rings 160 mounted in upper and lower ends of the membrane housing-module 100. A feed stream enters in a lower end of the membrane housing-module 100, via a feed stream inlet 102, with permeate exiting via the permeate outlet 154, and concentrate exiting via the concentrate outlet 104. Normally, the permeate inlet 152 is used for recirculation of permeate, but can also be used as an outlet, for example in case of draining, flushing, or cleaning of membrane housing-module 100.

In a related embodiment, a permeate inlet 152 can be used in a configuration of the membrane housing-module 100 configured with permeate recirculation.

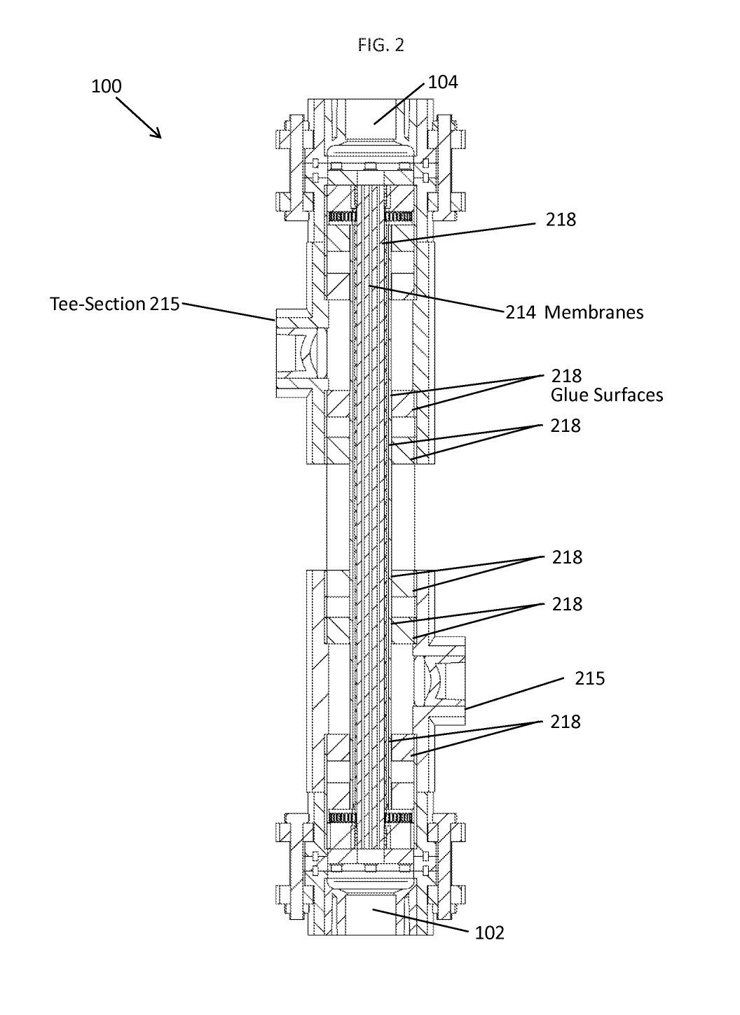

Referring to the embodiment of FIG. 2, a cross-sectional side view of the membrane housing-module 100 of FIG. 1 is shown. FIG. 2 shows a membrane housing-module having an elongated shape and membranes 214 installed therein. FIG. 2 shows glue surfaces 218, which provide structural integrity to the membrane housing-module 100 as well as tee-sections 215 for permeate outflow.

In a related embodiment, as shown in FIG. 2, a feed stream enters in a lower end of the membrane housing-module 100, via a feed stream inlet 102, such that the feed stream is directed through the membrane monolith 214, with permeate exiting via the permeate outlet 154, and a concentrate exiting via the concentrate outlet 104, in an upper end of the membrane housing-module.

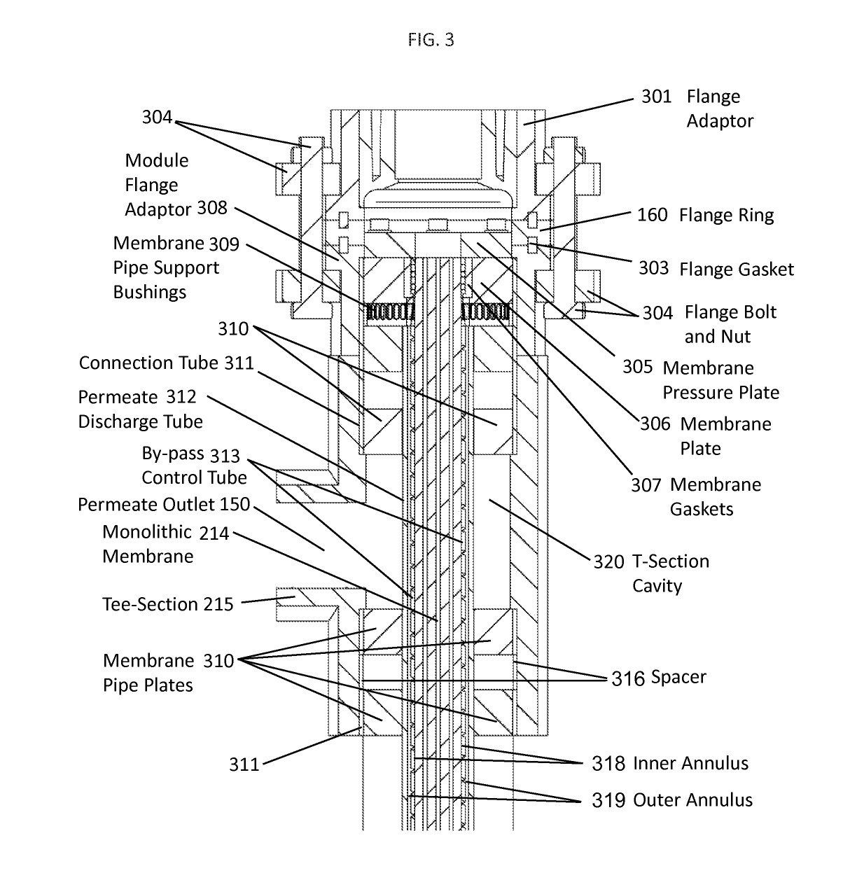

Referring to FIG. 3, a cross-sectional side view of an upper or lower half of the membrane housing-module of FIG. 2 is shown. The parts of the other half of the membrane housing shown in FIG. 3 may be designed to be identical or at least some parts may be provided in a mirror image configuration of the half shown in FIG. 3. FIG. 3 shows flange adapter 301 connecting the membrane housing-module to a membrane system using backing flanges and backing flange bolt and nuts 304. A flange ring 160 coupled with flange gaskets 303 on both sides is shown in between flange adapter 301 and module flange adapter 308 to accommodate required clearance for bolts used to fasten membrane pressure plate 305 to membrane plate 306. The membrane pressure plate 305 is positioned relative to membrane plate 306 so as to compress membrane gaskets 307. Accordingly, the membrane pressure plate 305 creates a seal between the concentrate phase and the permeate phase.

FIG. 3 shows a permeate discharge tube 312 adhered, e.g., glued inside apertures of membrane pipe plates 310. Membrane pipe plates 310 are shown adhered to the interior of the lower portions of the tee-section 215 and to a tube 311 connecting flange adapter 301 to the tee-section 215 at its upper portion above permeate outlet 154, which tube is hereinafter referred to as “flange adapter tee connection tube” 311. Flange adapter tee connection tube 311 is shown adhered to the tee-section 215 at its upper portion above permeate outlet 154. Spacers 316 placed between membrane pipe plates 310 provide precise spacing between membrane pipe plates 310.

Perforated membrane pipe support bushings 309 are arranged between a membrane plates 306 and membrane pipe plates 310, such that the membrane pipe support bushings are mounted around an end of the membrane monolith 214, wherein the end of the membrane monolith 214 protrudes from the permeate discharge tube 312, such that the perforated membrane pipe support bushings 309 functions as a spacer to ensure a space is left open between the upper end of the permeate discharge tube 312 and the seal, created by the membrane pressure plate 306 and the membrane plate 305, whereby permeate can flow from the permeate discharge chamber 1102, as shown in FIG. 11, in the upper end of the permeate discharge tube 312, through the perforations of the perforated membrane pipe support bushings 309, into the cavity 320 of the t-section 215, and then out via the permeate outlet 154.

In related embodiments, the membrane monolith 214, should be configured according to conventional design principles for elongated membranes, well-known to those with skill in the art, such that permeate filtrate is emitted from porous outer sides of the membrane 214, along the entire elongated length of the membrane 214, and concentrate flows along the length of the membrane, such that feed liquid enters from a lower end of the membrane 214 and is emitted as concentrate in an upper end of the membrane 214.

In one embodiment, the present invention includes manufacture and use of a membrane housing-module configured with constant trans-membrane pressure. For manufacture and use in such a configuration, a by-pass control tube 313 can be provided inside permeate discharge tube 312. Such a by-pass control tube 313 can allow for a pressure drop over the elongated length of the inner annulus 318 between the outer surface of the monolithic membrane 214 and the inner surface of by-pass control tube 313. The by-pass control tube 313 can be constructed such that the pressure drop over the by-pass control tube 313 is reduced along the path of permeate-filtrate flow towards the discharge of permeate-filtrate through perforated membrane pipe support bushings 309, and in the direction of the permeate outlet 154.

In this embodiment, permeate will flow upwards in the permeate discharge chamber 1102, between the outer surface of the monolithic membrane 214 and the permeate discharge tube 312, on each side of the by-pass control tube 313, as a combination of a first flow in the inner annulus 118, between the outer surface of the monolithic membrane 214 and the inner surface of the by-pass control tube 313, and a second flow in an outer annulus 319, between the outer surface of the bypass control tube 313 and the inner surface of the permeate discharge tube 312.

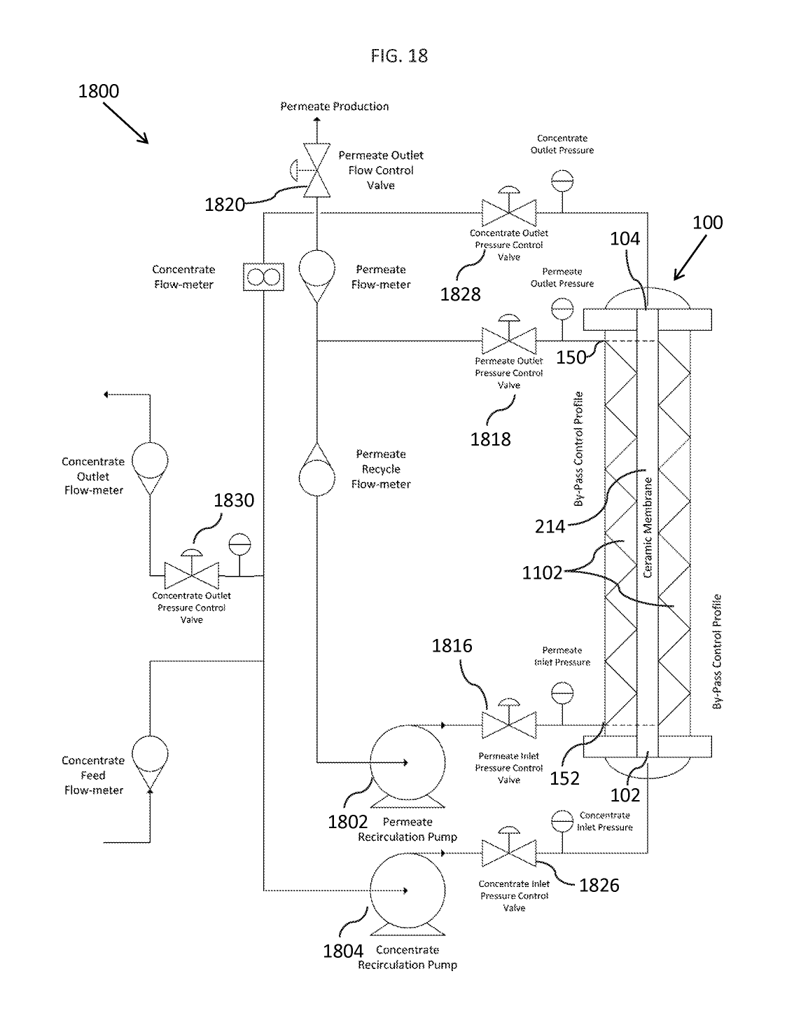

In a related embodiment, a reduced pressure drop can be achieved by increasing the open area of the by-pass control tube 313. A fixed open area, as proposed by existing technologies, fails due to the increased flow through this channel, caused by increased permeate production along the path of permeate-filtrate production. Permeate production at the beginning of by-pass control tube 313, is 0% of the membrane and at the end of the by-pass control tube 313 the permeate production has increased to 100%. The constant trans-membrane pressure can be controlled either by utilizing a forced recirculation flow, e.g., using a permeate-filtrate recirculation pump 1802, shown in FIG. 18, or by using a constant pressure drop control valve 1818 in the permeate-filtrate discharge line.

In a related embodiment, a membrane housing-module configured with constant trans-membrane pressure, can use permeate recirculation in the permeate collection chambers 1102, shown in FIG. 11, which are formed by the pipes around the ceramic monolithic membranes, between an outer sidewall of the membrane 214 and an inner wall of the permeate discharge tube 312.

In a related embodiment, FIG. 18. Shows a configuration of recirculation flow 1800 established for a membrane housing-module 100, with a permeate recirculation pump 1802, configured for permeate recirculation, and a concentrate recirculation pump 1804, configured for concentrate recirculation. As shown, the recirculation flow can be configured such that:
a. The permeate recirculation pump 1802 is configured in fluid connection between a permeate outlet 154 and a permeate inlet 152, such that a proportion of permeate flow is directed back into the permeate chamber 1102, under control of first and second permeate outlet flow control valve 1818 1820, and a permeate inlet flow control valve 1816;
b. The concentrate recirculation pump 1804 is configured in fluid connection between a concentrate outlet 104 and a concentrate inlet 102, such that a proportion of concentrate flow is directed back into the concentrate inlet 102, under control of first and second concentrate outlet flow/pressure control valves 1828 1830, and a concentrate inlet flow/pressure control valve 1826.

In a related embodiment, in a membrane housing-module configured with constant trans-membrane pressure, the pressure drop along the ceramic membrane in this permeate chamber is controlled in such a way that the pressure drop along the permeate side of the ceramic membrane is identical to the pressure drop along the concentrate flow in the ceramic membrane. In order to reduce the flow in the permeate chamber 1102, a pressure drop/turbulence promoter is used, in the form of a by-pass control tube 313, which will reduce the required flow in the permeate chamber 1102, but still produce the required pressure drop, thereby reducing the energy consumption of the by-pass flow. The by-pas flow will stay constant, once the required pressure drop is obtained. The required flow is very much depending on the required constant trans-membrane pressure and this value changes per application.

In a related embodiment, the by-pass control tube 313 can be function as a turbulence promoter, which serves to reduce drag on the permeate, whereby the pressure drop is created with a low energy expenditure.

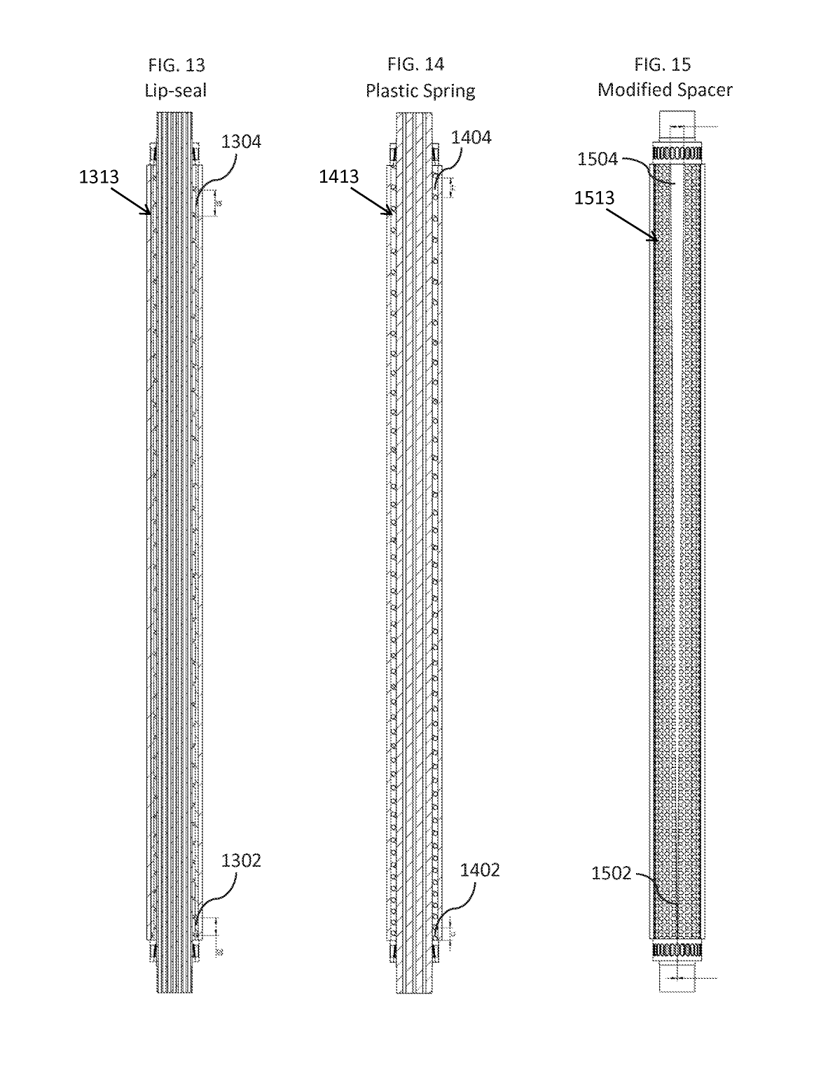

This permeate production will be zero at the beginning (or lower end, with reference to FIGS. 13-15) of the ceramic membrane but will be 100% of permeate produced by the ceramic membrane at the end (or upper end, with reference to FIGS. 13-15) of the permeate chamber. This will therefore result in an increased flow over the permeate channel, and if not compensated for, will affect the constant trans-membrane pressure of the unit. Therefore, in order to compensate for the increase of flow in the permeate collection chambers 1102, a by-pass control tube 313 can be arranged in a number of different configurations, such that an opening of the by-pass control tube 313 increases along the length of the membrane 214, including with:
a. A variable pitch in a “lip-seal” type of by-pass control tube 1313, regulating the permeate recycle flow/production, such that the pitch increases along the length of the by-pass control tube 1313, from a small pitch 1302 to a large pitch 1304, as shown in FIG. 13;
b. A variable pitch in a spring type of by-pass control tube 1413, regulating the permeate recycle flow/production, such that the pitch between coils of the spring increases along the length of the by-pass control tube 1413, from a small pitch 1402 to a large pitch 1404, as shown in FIG. 14; or
c. A variable opening, cutout area, or slit in a spacer type of by-pass control tube 1513, regulating the permeate recycle flow/production, such that the opening of the slit increases along the length of the by-pass control tube 1513, from a small opening 1502 to a large opening 1504, as shown in FIG. 15.

In a related embodiment, a lip-seal type of by-pass control tube 313 can be configured with flow-through holes, such that the flow-through is increased, corresponding to increased permeate flow.

In related embodiments, materials for manufacturing the by-pass control tube 313 can include:
a. PVC/ABS/Polypropylene and other hard plastic materials
b. Rubber type materials, such as Buna, neoprene, silicon, Viton, various other types of natural or synthetic rubber, and similar rubber-like materials; or
c. Rubber type materials with an inner core stainless steel wire construction.

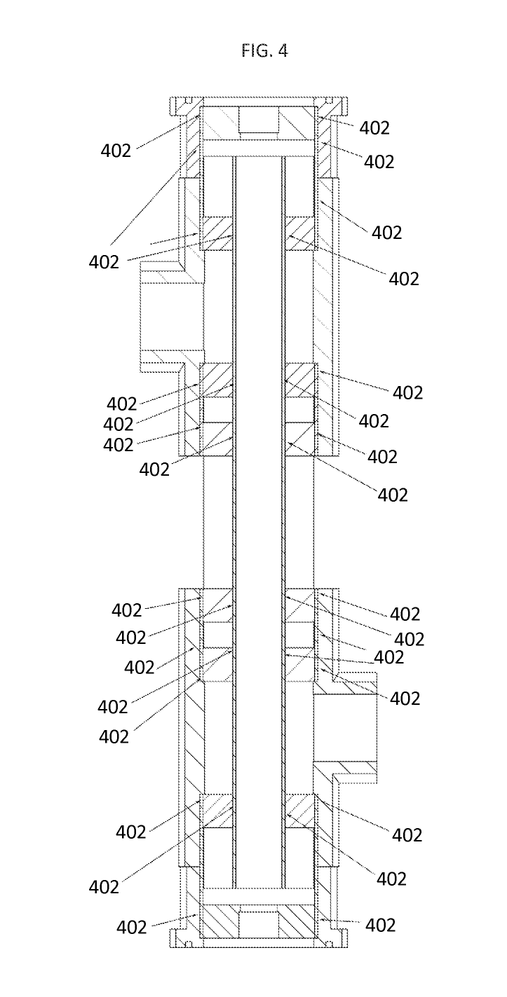

In an embodiment, FIG. 4 shows preferred surfaces 402 for adhering membrane housing elements of the embodiment of FIG. 1 to each other.

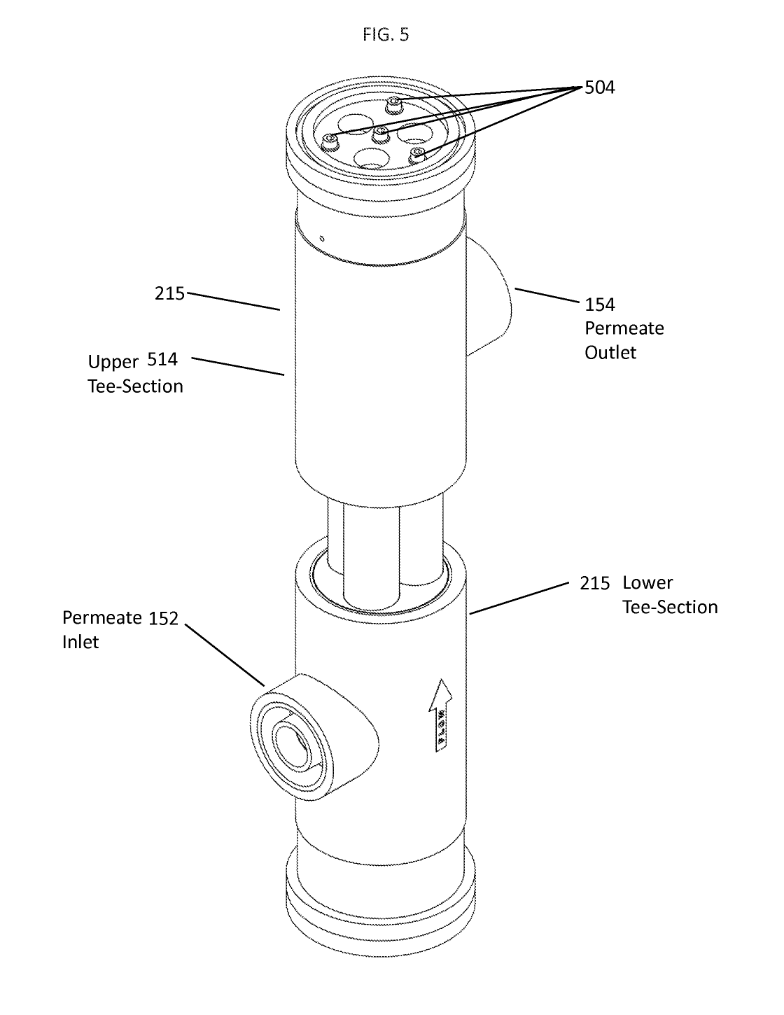

Referring to FIGS. 5-11, various views of the embodiment of FIG. 1 are shown having progressively fewer parts in order to demonstrate the assembly of the exemplary embodiment of the membrane housing-module of FIG. 1.

Referring to FIG. 5, an exemplary embodiment of the membrane housing-module of FIG. 1 is shown having the flange ring 160 removed. FIG. 5 also shows bolts 504.

In a related embodiment, FIG. 5 shows the membrane housing-module 100 configured with two t-sections 215, which are an upper t-section 514, which comprises the permeate outlet 154; and a lower t-section, which comprises the permeate inlet 152.

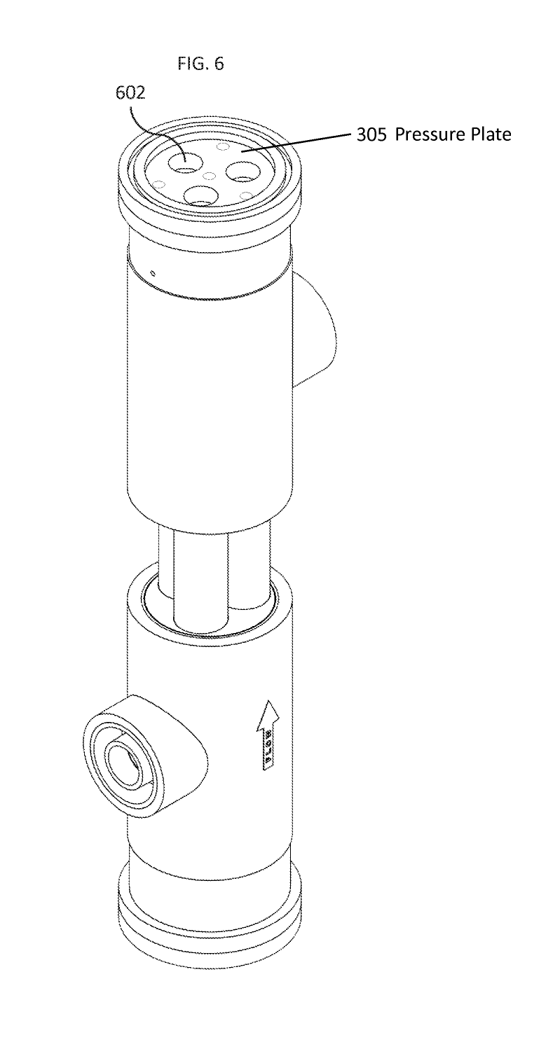

Referring to FIG. 6, an exemplary embodiment of the membrane housing-module of FIG. 5 is shown having the bolts 504 removed. FIG. 6 also shows membrane pressure plate 305, which includes concentrate apertures 602, which pass through the membrane pressure plate, to allow flow of concentrate.

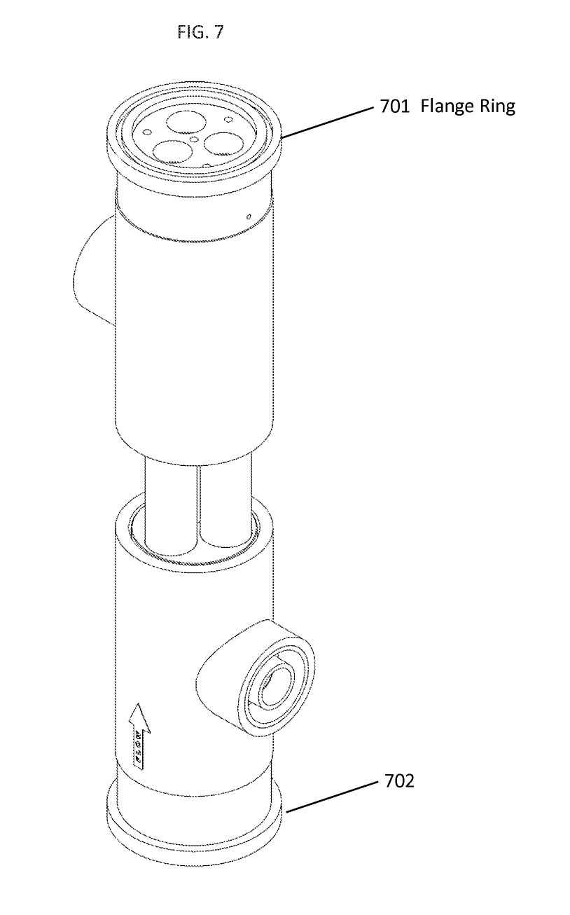

Referring to FIG. 7, an exemplary embodiment of the membrane housing-module of FIG. 6 is shown having the membrane pressure plate 305 removed. FIG. 7 also shows flange rings 160, respectively an upper flange ring 701 and a lower flange ring 702, mounted at respectively an upper and lower end of the membrane housing module.

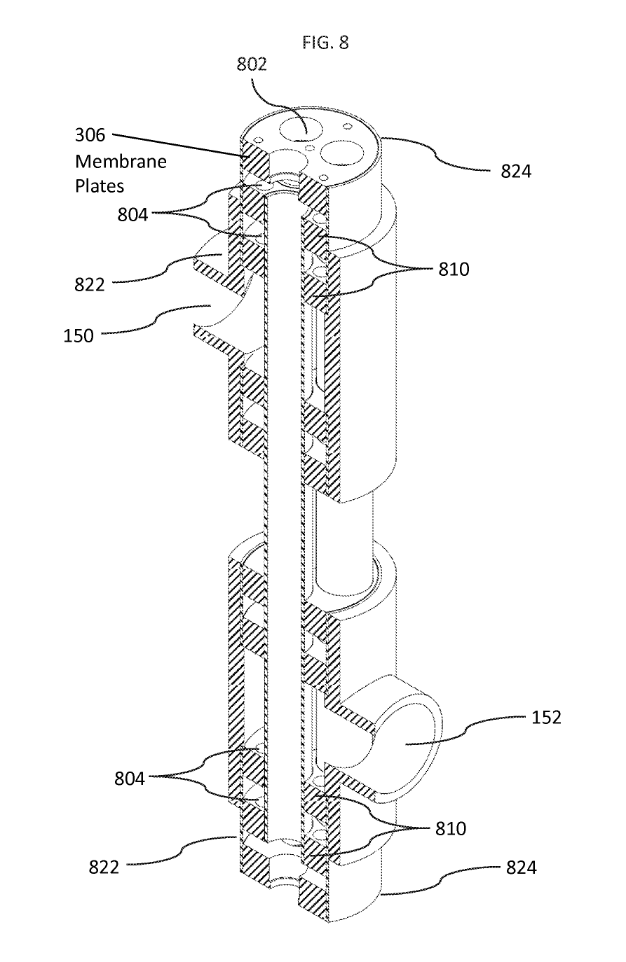

Referring to FIG. 8, a cross-section view of an exemplary embodiment of the membrane housing-module of FIG. 7 is shown having the flange rings 701 702 removed. FIG. 8 also shows membrane plate 306, which includes concentrate apertures 802, which pass through the membrane plate 306, to allow flow of concentrate.

In a related embodiment, as shown in FIG. 8, membrane pipe plates 810, which are located within an outer part 822 of a t-section 315, can include permeate apertures 804, to allow a fluid connection for permeate discharge to the permeate outlet 154, or to permeate inlet 152.

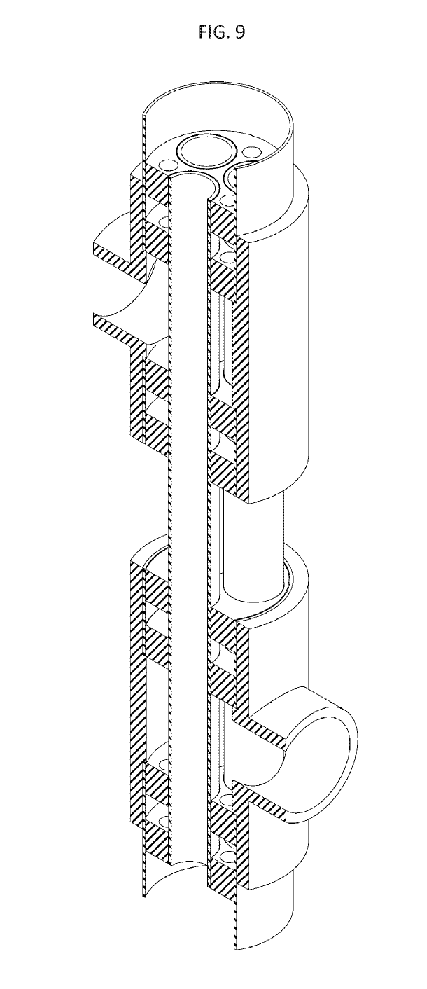

Referring to FIG. 9, a cross-section view of an exemplary embodiment of the membrane housing-module of FIG. 8 is shown having the membrane plates 306 removed.

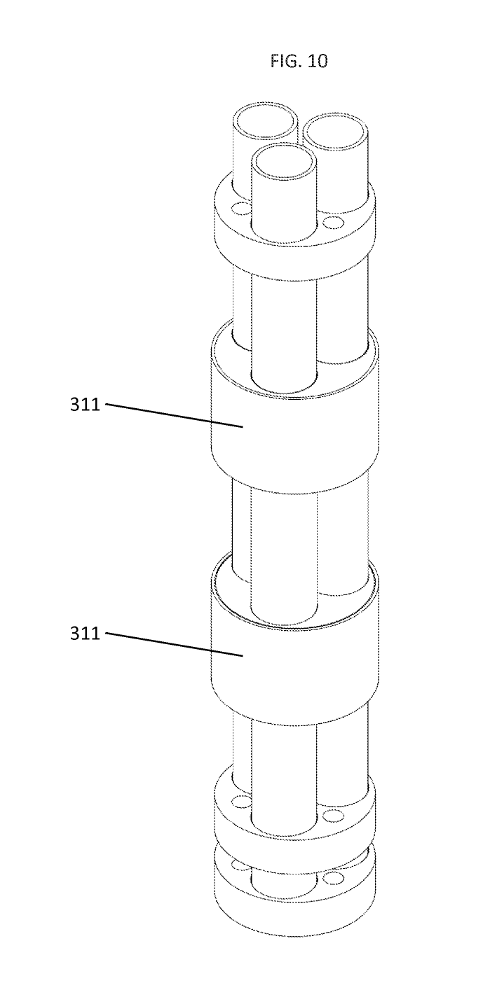

FIG. 10 shows an example embodiment, with a pipe bundle of three pipes. Generally, the pipe bundle according to an embodiment of the present invention may include one or more pipes, e.g., 1 to 100 pipes. An embodiment containing three pipes is shown in FIG. 10, which also shows connection tubes 311.

FIG. 11 shows the pipe bundle of FIG. 10 where the connection tubes 311 around the membrane pipe plates 310 have been removed, further showing the membrane pipe plates 310 mounted around the permeate discharge tubes 312.

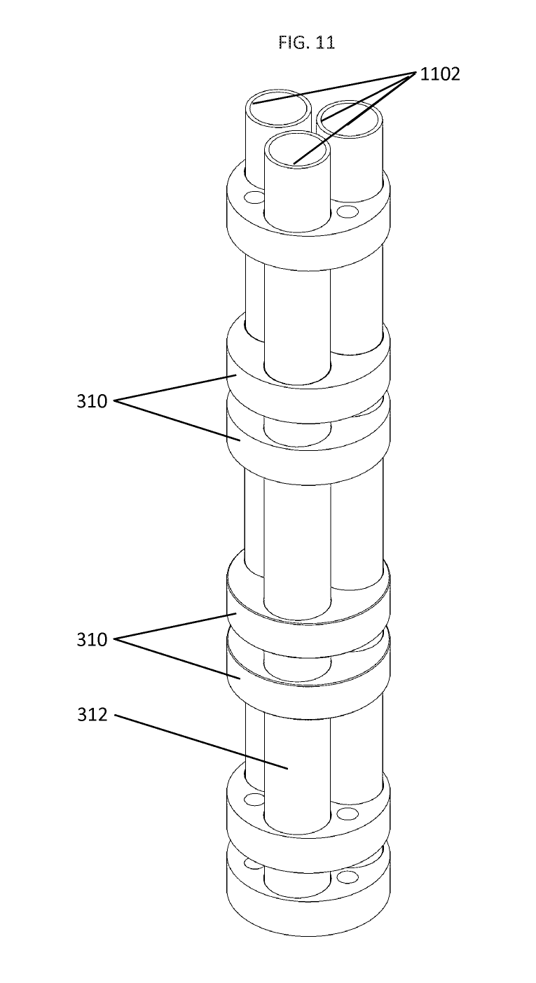

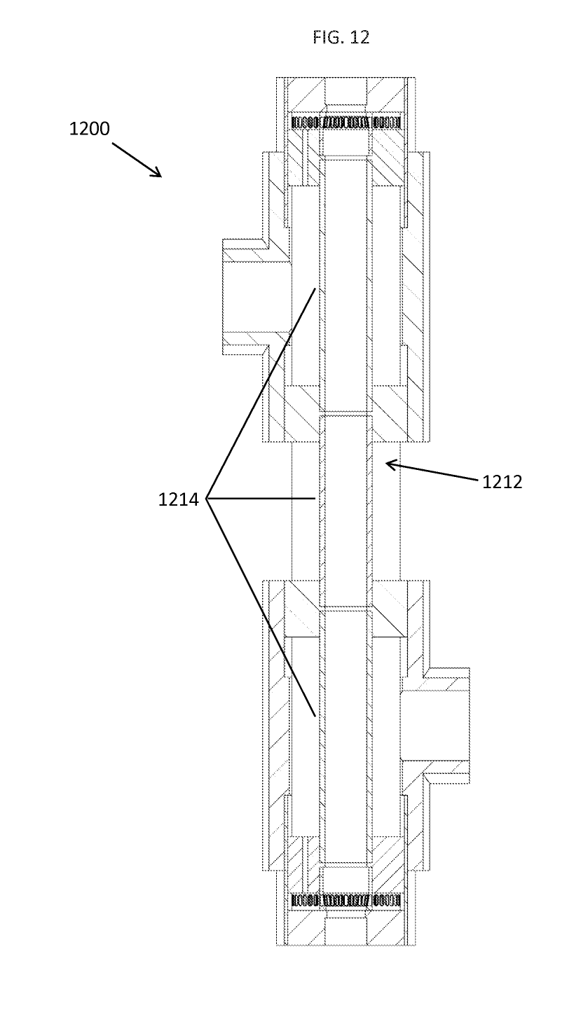

FIG. 12 shows an alternative embodiment of a membrane housing-module 1200, wherein the permeate discharge tubes 1212, is configured in interconnected segments 1214, which facilitate manufacturing assembly of the membrane housing-module 1200.

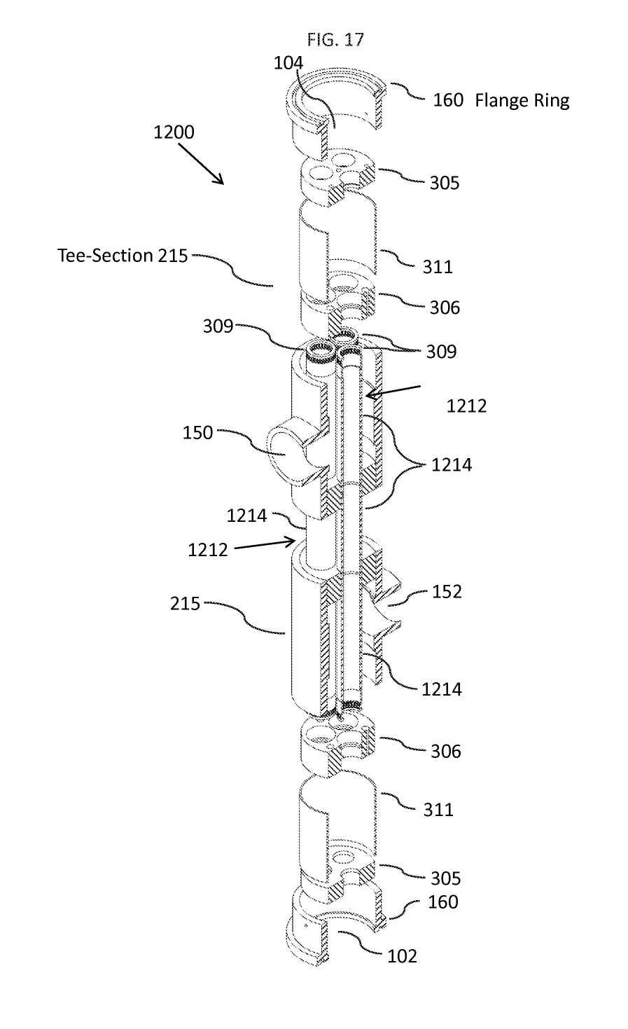

FIG. 17 shows a section-cut perspective view of a related embodiment, wherein the permeate discharge tubes 1212, are configured in interconnected segments 1214.

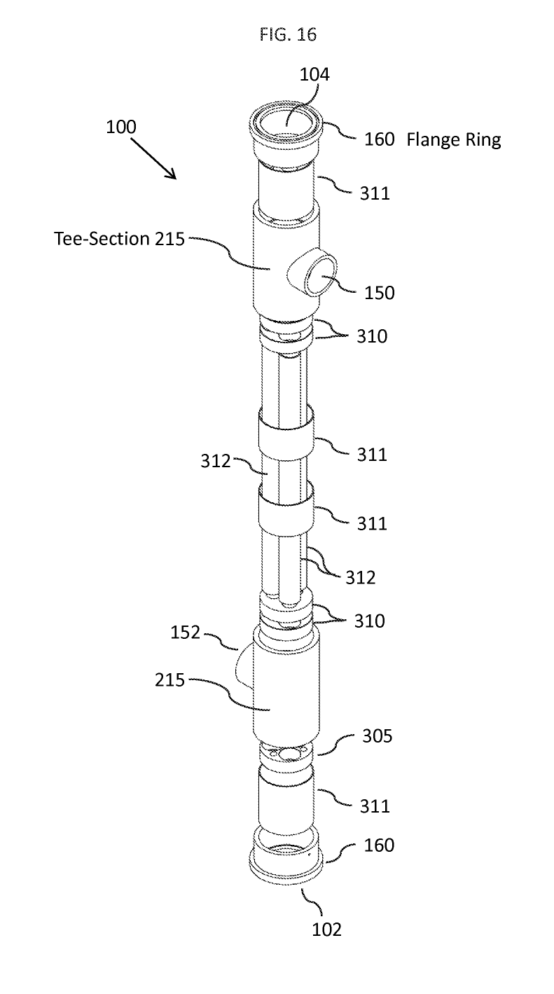

In a related embodiment, FIG. 16 shows an exploded perspective view of the membrane housing-module 100.

According to various embodiments of the invention, a membrane housing-module is constructed to support one or more membrane(s) surrounded by membrane housing-module elements. In certain embodiments, the membrane housing-module elements are configured so as to provide lateral rigidity to the membrane housing-module assembly. The lateral rigidity can be sufficient so as to prevent lateral forces generated during operation of the membrane assembly from damaging any membranes installed in the membrane housing-module of the present invention. While membranes can be installed into the membrane housing-module, the membranes themselves should not be used as part of the structure for providing lateral rigidity.

In some embodiments, the membrane is installed in a three-dimensional membrane pipe. For example, at least one membrane pipe may be used having a cylindrical shape. Particularly, the present invention may include one or more ceramic membrane monoliths, extending through the length of one or more membrane pipes.

In some embodiments, the membrane housing-module of the present invention has an elongated body having an end configured to receive membranes to be inserted into the membrane housing-module. In an embodiment, one or more elongated membrane pipes may be inserted at the insertion end of the elongated membrane housing-module. One or more membranes can be installed in each of the elongated membrane pipes.

In some embodiments, any number of membrane monoliths and membrane pipe plates may be used. For example, the membrane housing-module may house up to 100 membrane monoliths and up to 100 membrane pipe plates. The number is defined by the size and diameter of the chosen parts for the construction. In some embodiments, the membrane housing-module includes three membrane monoliths. In related embodiments, the membrane monoliths comprise or consist of ceramic membrane monoliths.

Membrane housing-modules according to embodiments of the present invention are constructed with high precision so that membranes can efficiently and safely be inserted into and removed from the membrane housing-module.

According to embodiments of the present invention, a membrane housing-module is provided having an elongated body forming a seal between the concentrate phase and permeate phase and a plurality of glue surfaces arranged so as to provide sufficient structural integrity to the membrane housing-module such that when one or more membranes are inserted therein, the membrane housing assembly is rigid so as to prevent the membranes from being subjected to lateral forces or movement during use. According to embodiments of the present invention, the membrane housing-module may be configured to house at least one membrane monolith. The number of membranes can be varied by varying the size and diameter of the elements selected for manufacturing a membrane housing-module according to embodiments of the present invention.

In certain embodiments, the present invention includes a membrane housing-module having a plurality membrane housing-module elements assembled so as to be adhered at a plurality of glue surfaces. The membrane housing-module elements and the locations of the glue surfaces should be selected so as to provide lateral rigidity to membrane(s) installed into the membrane housing-module. In some embodiments, the present invention may be configured to include permeate discharge tubes adhered in membrane pipe plates that are adhered to a tee-section and a flange adaptor tee connection tube. In certain embodiments, the flange adaptor tee connection tube may also be glued to the tee-section.

In contrast to conventional membrane housing-modules made from plastic materials, embodiments of the present invention relate to a membrane housing-module designed to have the same stiffness and resistance to lateral movements as conventional metal membrane housing-modules. According to embodiments of the present invention, the combination of a plurality of tubes and a plurality of glue surfaces prevents movement of the membrane housing-module elements during operation. Embodiments of the present invention can use a sufficiently high number of adhered parts, which imparts high stiffness into the membrane housing-module and prevents movement of the adhered elements from which the membrane housing-module is constructed in relation to each other as well as any membranes installed in the membrane housing-module. In related embodiments, the design of the glue surfaces limits, i.e. prevents, the movement of membrane housing-module elements to achieve the same stiffness and rigidity as conventional metal housing/module designs. Moreover, embodiments of the present invention can allow for chemically resistant designs similar to the higher-grade alloy designs, but at a substantially lower manufacturing cost.

The use of the multiple tube components in the membrane housing-module can produce additional benefits in the hydraulic configuration of the membrane separation process according to embodiments of the present invention. In certain embodiments, because each membrane has its own permeate-filtrate discharge chamber 1102, such as shown with 3 permeate-filtrate discharge chamber 1102 in FIG. 11, the presence of this individual discharge chamber allows for inserts, e.g., plastic inserts, between each ceramic monolith and an inside pipe diameter. Inserts can provide control over the flow through the permeate-filtrate discharge chambers 1102, and also provide control over the membrane filtration/separation processes of the present invention.

In various embodiments, glue surfaces of the membrane housing elements can be adhered using a suitable adhesive substance. Suitable adhesive substances can include solvent-glue-cement, two compound epoxy glue, and single and two compound polyurethane glue.

In various related embodiments, membrane housing elements in the membrane housing-module 100 can be made from various plastic materials. Most polymers sometimes referred to as resins, may be used, including all thermoplastics, some thermosets, and some elastomers. Examples of suitable plastic materials are: ABS acrylonitrile butadiene styrene); polyoxymethylene (acetal plastic); high density polyethylene; low density polyethylene; nylon; glass fiber filled nylon; polyetherimide; polycarbonate; polyvinyl chloride and other thermoplastic elastomers.

In related embodiments, plastic components can be made from high temperature thermoplastic polymers or Carbon-Fiber-Epoxy Composites.

In various embodiments, a ceramic membrane 214 can have a diameter of 25-40 mm. In alternative embodiments, the diameter can be smaller or larger than this range. For larger diameters than 40 mm control over the bypass will become more and more difficult, as outer diameter of the ceramic membrane 214 increases.

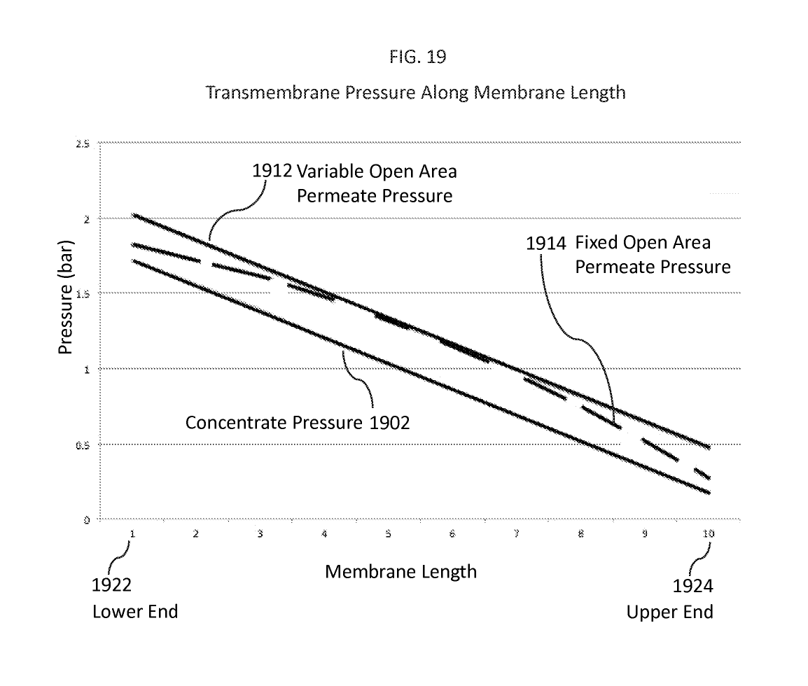

In example embodiments, a 42 mm diameter ceramic monolithic membrane 214 can be configured such that:
a. The length of the membrane can be from 500 mm to 1500 mm, and in most application can be between 500 and 1200 mm. Typically, a 42 mm membrane will have outer ends that are reduced to 40 mm in diameter, in order to facilitate fitting of seals and gaskets;
b. The inside diameter of the permeate discharge tube 312 around the ceramic membrane 214 can be between 46 and 56 mm, which gives an annulus, of the permeate discharge chamber 1102, of 2-7 mm as a by-pass dimension;
c. The pressure drop over the by-pass control tube 313 insert in this annulus depends on the open area and the flow through the by-pass control tube 313;
d. The additional open area of the by-pass control tube 313, which can be a plastic insert, will allow the permeate production (additional flow through the annulus) of the ceramic membrane to leave the annulus without increasing the pressure drop. If this is not taken into consideration, this additional flow will negatively influence the pressure drop over the annulus and influence the constant trans-membrane pressure;
   i. FIG. 19 shows the concentrate pressure 1902, the variable open area permeate pressure 1912, the fixed open area permeate pressure 1914, across the length of the membrane 214, from a lower end 1922 of the by-pass control tube 313, to an upper end 1924 of the by-pass control tube 313, and illustrates how the trans-membrane pressure can be kept constant, by the by-pass-control tube 313, in comparison to the variable trans-membrane pressure resulting from not compensating for the additional permeate flow, which then causes inefficient membrane utilization.
   ii. FIG. 19 shows a diagram of non-uniform permeate production when the open area is not adjusted to handle the additional flow created by the ceramic membrane. This loss of net permeate production is substantial and can be as much as 30% of the total production of the ceramic membrane. It also affects the separation efficiencies since the trans-membrane pressure conditions are no longer uniform over the ceramic membrane. This will result in loss of efficiency in the separation process and additional fouling and additional cleaning of the membrane surface.
e. In a configuration for Micro-Filtration trans-membrane pressure should be maintained in a range of 0.5-0.8 bar;
f. The required concentrate pressures and pressure drops are substantial higher and depending on the required cross-flow velocity can vary from 2-3 bar with pressure drops in the range of 1-1.8 bar;

More specifically, embodiments of the present invention relate to the reactor apparatus, processes and uses described below.

Item 1. A membrane housing-module comprising:
a) an elongated body having a flange adaptor at each end of said elongated body and at least one membrane pipe therein, said membrane pipe adapted to receive at least one membrane monolith in its interior portion and surrounded by a permeate discharge tube 312;
b) a plurality of membrane pipe plates disposed within said elongated body between each of said at least one membrane pipe and one or more tee-sections; and
c) a flange adapter tee connection tube;
wherein said elements are adhered to each other at glue surfaces on said membrane pipe plates, said one or more tee-sections, said permeate discharge tube and said flange adapter tee connection tube.

Item 2. The membrane housing-module of item 1, wherein said permeate discharge tube is adhered in said membrane pipe plates.

Item 3. The membrane housing-module of any of items 1-2, wherein at least one of said membrane pipe plates is adhered to said permeate discharge tube and an interior portion of said one or more tee-sections.

Item 4. The membrane housing-module of any of items 1-3, wherein at least one of said membrane pipe plates is adhered to said permeate discharge tube and to said flange adapter tee connection tube.

Item 5. The membrane housing-module of any of items 1-4, further comprising at least one spacer between at least two of said membrane pipe plates.

Item 6. The membrane housing-module of any of items 1-5, further comprising a by-pass control tube arranged inside said permeate discharge tube.

Item 7. The membrane housing-module of any of items 1-6, wherein said by-pass control tube creates a pressure drop over an inner annulus between a membrane monolith installed within said membrane pipe and an interior portion of said by-pass control tube.

Item 8. The membrane housing-module of any of items 1-7, further comprising membrane pipe support bushings.

Item 9. The membrane housing-module of any of items 1-8, wherein said membrane pipe support bushings are perforated.

Item 10. The membrane housing-module of any of items 1-9, further comprising a membrane housing-module outlet.

Item 11. The membrane housing-module of any of items 1-10, wherein said by-pass control tube is provided such that said pressure drop over the by-pass control tube is reduced along a path of permeate-filtrate flow towards discharge of permeate-filtrate through said perforated membrane pipe support bushings and towards said membrane housing-module outlet.

Item 12. The membrane housing-module of any of items 1-11, further comprising at least one membrane monolith inserted therein, wherein said membrane housing-module forms a seal between a concentrate phase and a permeate phase of said membrane monolith.

Item 13. The membrane housing-module of any of items 1-12, wherein said membrane housing-module is rigid so as to prevent membranes inserted therein from being subjected to lateral forces or movement during operation.

Item 14. The membrane housing-module of any of items 1-13, wherein said one or more tee-sections are constructed from plastic materials.

Item 15. The membrane housing-module of any of items 1-14, further comprising a flange adaptor at each of its two ends.

Item 16. The membrane housing-module of any of items 1-15, wherein each of said flange adaptors is coupled with flange gaskets on each of its sides.

Item 17. The membrane housing-module of any of items 1-16, wherein said flange adaptor connects the membrane housing-module to a membrane system in said membrane housing-module.

Item 18. The membrane housing-module of any of items 1-17, wherein said flange adaptor secures said membrane system in said membrane housing-module via securing means, preferably said securing means include one or more flange bolt and flange nut.

Item 19. The membrane housing-module of any of items 1-18, further comprising a membrane pressure plate fastened to a membrane plate.

Item 20. The membrane housing-module of any of items 1-19, further comprising a module flange adapter provided as means for accommodating fastening of said membrane pressure plate to said membrane plate.

Item 21. The membrane housing-module of any of items 1-20, wherein said membrane pressure plate is positioned relative to said membrane plate so as to compress membrane gaskets between said membrane plate and a membrane installed in said membrane housing-module.

Item 22. The membrane housing-module of any of items 1-21, wherein said membrane pressure plate forms a seal between a concentrate phase and a permeate phase in said membrane housing-module.

Item 23. The membrane housing-module of any of items 1-22, wherein said membrane housing-module is operable in a constant permeate flux regime.

Item 24. The membrane housing-module of any of items 1-23, wherein said membrane housing-module is operable in a constant trans-membrane pressure regime.

Item 25. The membrane housing-module of any of items 1-24, further comprising a by-pass control tube provided inside said permeate discharge tube.

Item 26. The membrane housing-module of any of items 1-25, wherein said by-pass control tube is adapted for creating a pressure drop over an inner annulus between the outside of the monolithic membrane and the inside of said by-pass control tube.

Item 27. The membrane housing-module of any of items 1-26, wherein said by-pass control tube is constructed such that the pressure drop over the by-pass control tube is reduced along a permeate-filtrate flow path towards the discharge of permeate-filtrate flow through said membrane pipe support bushings and in the direction of a membrane housing-module outlet.

Item 28. The membrane housing-module of any of items 1-27, wherein said reduced pressure drop is achieved by increasing the open area of the by-pass control tube.

Item 29. The membrane housing-module of any of items 1-28, further comprising a forced recirculation flow of said permeate-filtrate flow.

Item 30. The membrane housing-module of any of items 1-29, further comprising a permeate-filtrate recirculation pump.

Item 31. The membrane housing-module of any of items 1-30, further comprising a constant pressure drop control valve.

Item 32. The membrane housing-module of any of items 1-31, wherein said constant pressure drop control valve is located in the permeate-filtrate discharge line.

Item 33. The membrane housing-module of any of items 1-32, wherein at least one membrane pipe has a cylindrical shape.

Item 34. The membrane housing-module of any of items 1-33, wherein each membrane installed in said membrane housing-module has a permeate-filtrate discharge chamber for receiving permeate-filtrate.

Item 35. The membrane housing-module of any of items 1-34, further comprising inserts between each of said one or more membrane monoliths and an inside pipe diameter having a pre-determined configuration and shape.

Item 36. The membrane housing-module of any of items 1-35, wherein inserts between each of said one or more membrane monoliths and an inside pipe diameter are operable to control flow through the permeate-filtrate discharge chambers by the restriction that the inserts create in the permeate flow.

Item 37. The membrane housing-module of any of items 1-36, wherein inserts between each of said one or more membrane monoliths and an inside pipe diameter with the predetermined configuration and shape are operable to provide control over the membrane filtration/separation processes of the one or more membrane installed in said membrane housing-module by allowing a controlled flow at a set pressure drop over the inserts.

Item 38. The membrane housing-module of any of items 1-37, wherein said membrane housing-module elements are constructed from plastic materials.

Item 39. The membrane housing-module of any of items 1-38, wherein said membrane housing-module is adapted to receive at least one membrane monolith.

Item 40. The membrane housing-module of any of items 1-39, wherein said membrane housing-module is adapted to receive 1 to 100 membrane monoliths.

Item 41. The membrane housing-module of any of items 1-40, wherein said membrane housing-module is adapted to receive three membrane monoliths.

Item 42. The membrane housing-module of any of items 1-41, wherein said membrane monolith is a ceramic membrane monolith.

Item 43. The membrane housing-module of any of items 1-42, wherein said membrane housing-module has sufficient structural integrity and lateral stiffness for performing membrane separation processes therein without using the inserted membranes as a part of the supporting structure.

Item 44. The membrane housing-module of any of items 1-43, wherein said membrane housing-module elements are adhered such that said membrane housing-module has sufficient structural integrity and lateral stiffness for performing membrane separation processes therein and avoiding breakage of the inserted membranes as a result of forces generated during use.

Item 45. The membrane housing-module of any of items 1-44, wherein said membrane housing-module has individual plastic tubes and membrane pipe plates glued in place to form a support structure for said membrane housing-module and to form individual permeate discharge chambers.

Item 46. The membrane housing-module of any of items 1-45, wherein said individual permeate chambers in combination with by-pass pressure and flow control create a constant trans-membrane pressure along the length of said one or more membrane monoliths.

Item 47. The membrane housing-module of any of items 1-46, having a constant trans-membrane pressure along the length of said one or more membrane monoliths and through the by-pass control tube created by by-pass pressure and control of the permeate-filtrate flow.

Item 48. A method of manufacturing the membrane housing module of any of items 1-47, comprising providing membrane housing module elements and adhering said membrane housing module elements to each other at glue surfaces on said membrane pipe plates, said one or more tee-sections, said permeate discharge tube and said flange adapter tee connection tube.

Item 49. A method of membrane separation comprising providing the membrane housing module of any of items 1-48, installing at least one membrane in said membrane housing module, flowing a liquid to be treated into said membrane housing module through an inlet, performing a membrane separation across said at least one membrane such that the pressure drop over the by-pass control tube is reduced along a permeate-filtrate flow path towards the discharge of permeate-filtrate flow through said membrane pipe support bushings and in the direction of a membrane housing-module outlet.

Item 50. Use of the membrane housing-module of any of items 1-49 for performing membrane separation of a liquid to be treated by membrane separation.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A membrane housing-module comprising as elements:
a) at least one permeate discharge tube, configured to receive at least one membrane monolith in an interior portion of the permeate discharge tube;
b) at least one tee-section, which is an upper t-section, which further comprises a permeate outlet;
c) a plurality of membrane pipe plates mounted within the at least one tee-section, wherein the permeate discharge tube passes through pipe apertures in the membrane pipe plates; and
d) a flange adapter tee connection tube;
wherein the elements are adhered to each other at glue surfaces on the membrane pipe plates, the tee-section, the permeate discharge tube, and the flange adapter tee connection tube;
wherein the membrane housing-module is configured such that a feed stream enters in a lower end of the membrane housing-module, via a feed stream inlet, such that the feed stream is directed through the membrane monolith, with a permeate exiting via the permeate outlet, and a concentrate exiting via a concentrate outlet, in an upper end of the membrane housing-module.

2. The membrane housing-module of claim 1, wherein the permeate discharge tube is adhered to the pipe apertures in the membrane pipe plates.

3. The membrane housing-module of claim 1, wherein at least one of the membrane pipe plates is adhered to the permeate discharge tube and an interior portion of the tee-section.

4. The membrane housing-module of claim 1, wherein at least one of the membrane pipe plates is adhered to the permeate discharge tube and to the flange adapter tee connection tube.

5. The membrane housing-module of claim 1, further comprising at least one spacer between at least two of the membrane pipe plates.

6. The membrane housing-module of claim 1, further comprising a perforated membrane pipe support bushing, such that the perforated membrane pipe support bushing is mounted around an end of the membrane monolith, wherein the end of the membrane monolith protrudes from the permeate discharge tube, such that the perforated membrane pipe support bushing is configured to create a space wherein the permeate flows from a permeate discharge chamber in an upper end of the permeate discharge tube, through perforations of the perforated membrane pipe support bushing, into a cavity of the t-section, and then out via the permeate outlet.

7. The membrane housing-module of claim 6, further comprising a by-pass control tube arranged inside the permeate discharge tube, such that the by-pass control tube is configured to receive the membrane monolith in an interior portion of the by-pass control tube.

8. The membrane housing-module of claim 7, wherein the by-pass control tube is configured to create a pressure drop over an elongated length of an inner annulus between an outer surface of the membrane monolith, installed within the permeate discharge tube, and an inner surface of the by-pass control tube.

9. The membrane housing-module of claim 8, wherein the by-pass control tube is configured such that the pressure drop over the by-pass control tube is reduced along a path of permeate-filtrate flow towards discharge of permeate-filtrate through the perforated membrane pipe support bushings, in a direction of the membrane housing-module permeate outlet.

10. The membrane housing-module of claim 9, wherein the by-pass control tube is configured such that an opening of the by-pass control tube increases along a length of the membrane monolith.

11. The membrane housing-module of claim 10, wherein the by-pass control tube is a spring type of by-pass control tube, comprising a spring, which is configured with a variable pitch, such that the variable pitch between coils of the spring increases along the length of the by-pass control tube, from a small pitch to a large pitch.

12. The membrane housing-module of claim 1, further comprising at least one membrane monolith inserted in the permeate discharge tube, wherein the membrane housing-module is configured such that the membrane housing-module forms a seal between the concentrate and the permeate.

13. The membrane housing-module of claim 1, wherein the membrane housing-module is rigid, whereby the membrane housing-module prevents membranes inserted therein from being subjected to lateral forces or movement during operation.

14. The membrane housing-module of claim 1, wherein the tee-section is constructed from a plastic material.

15. The membrane housing-module of claim 6, further comprising a membrane plate, wherein the membrane plate is mounted around the end of the membrane monolith, above the membrane pipe support bushings, wherein the membrane plate comprises at least one concentrate aperture, which passes through the membrane plate, to allow the concentrate to pass through the membrane plate.

16. The membrane housing-module of claim 15, further comprising a membrane pressure plate, which comprises at least one concentrate aperture, which passes through the membrane pressure plate, to allow the concentrate to pass through the membrane pressure plate, wherein the membrane pressure plate is fastened to the membrane plate, such that the membrane pressure plate creates a seal between the concentrate and the permeate.

17. The membrane housing-module of claim 16, further comprising membrane gaskets, which are mounted between the membrane plate and the membrane monolith, such that the membrane pressure plate compresses the membrane gaskets.

18. The membrane housing-module of claim 17, further comprising a module flange adapter, which is mounted around the membrane pressure plate, such that it is configured to fasten the membrane pressure plate to the membrane plate with bolts.

19. The membrane housing-module of claim 18, further comprising a flange ring and flange gasket, such that the flange ring is mounted on top of the module flange adapter, such that the flange gasket is compressed between the flange ring and the module flange adapter, such that the flange ring creates clearance for bolts that are used to fasten the membrane pressure plate to the membrane plate.

20. The membrane housing-module of claim 19, further comprising upper and lower flange adaptors, such that the upper and lower flange adaptors are fastened at respectively upper and lower ends of the membrane housing-module with fastening mechanisms.

21. The membrane housing-module of claim 20, wherein the fastening mechanisms comprise flange bolts and flange nuts.

22. The membrane housing-module of claim 10, further comprising a configuration of forced recirculation flow of the permeate-filtrate flow, such that a proportion of permeate flow is directed back into a permeate chamber between the permeate discharge tube and the membrane monolith, via a fluid connection between the permeate outlet and a permeate inlet, which is configured in a lower tee-section.

23. The membrane housing-module of claim 10, further comprising a permeate-filtrate recirculation pump, such that the permeate filtrate recirculation pump is configured in a fluid connection between the permeate outlet and a permeate inlet, such that a proportion of permeate flow is directed back into a permeate chamber between the permeate discharge tube and the membrane monolith.

24. The membrane housing-module of claim 23, further comprising a constant pressure drop control valve, which is mounted in the fluid connection.

25. The membrane housing-module of claim 24, wherein the constant pressure drop control valve is mounted in the fluid connection between the permeate outlet and the permeate filtrate recirculation pump.

26. The membrane housing-module of claim 1, wherein the permeate discharge tube has a cylindrical shape.

27. The membrane housing-module of claim 1, wherein the membrane housing-module elements are constructed from plastic materials.

28. The membrane housing-module of claim 1, wherein the membrane housing-module comprises three permeate discharge tubes, such that the membrane housing-module is configured to receive three membrane monoliths.

29. The membrane housing-module of claim 1, further comprising the membrane monolith, wherein the membrane monolith is a ceramic membrane monolith.

30. The membrane housing-module of claim 1, wherein the membrane housing-module is configured with structural integrity and lateral stiffness, such that the membrane housing-module is operable for performing membrane separation processes, without flexing of or application of external forces to the membrane monolith.

31. The membrane housing-module of claim 1, wherein the permeate discharge tube and the membrane pipe plates are made from plastic, such that the permeate discharge tube and the membrane pipe plates are glued in place to form a support structure for the membrane housing-module, and to form individual permeate discharge chambers.

32. The membrane housing-module of claim 1, wherein the permeate discharge tubes are configured in interconnected segments, to facilitate manufacturing assembly of the membrane housing-module.

33. The membrane housing-module of claim 1, wherein membrane pipe plates which are located within an outer part of the t-section, include permeate apertures, to allow a fluid connection for permeate discharge to the permeate outlet.

34. A method of manufacturing the membrane housing module of claim 1, comprising providing membrane housing module elements and adhering the membrane housing module elements to each other at glue surfaces on membrane pipe plates, at least one tee-section, a permeate discharge tube, and a flange adapter tee connection tube.

35. A method of membrane separation, comprising:
a. providing the membrane housing module of claim 1;
b. installing at least one membrane monolith in the membrane housing module;
c. flowing a liquid to be treated into the membrane housing module through a concentrate inlet;
d. performing a membrane separation across the at least one membrane monolith, such that a pressure drop over a by-pass control tube is reduced along a permeate-filtrate flow path towards discharge of permeate-filtrate flow through membrane pipe support bushings, in direction of a permeate outlet.

36. A method of using the membrane housing-module of claim 1 for performing membrane separation of a liquid to be treated by membrane separation.
